(19) United States
(12) Patent Application Publication
(10) Pub. No.: US 2002/0085111 A1
(43) Pub. Date: Jul. 4, 2002

(54) Method and apparatus for providing travel information

(76) Inventor: Arie Heiman, Raanana (IL)

Correspondence Address: David Klein, DEKEL PATENT LTD., 12 HaEgoz Street, Apt. 4, REHOVOT, IL

(21) Appl. No.: 09/752,523

(22) Filed: Jan. 3, 2001

(51) Int. Cl. H04N 5/225

(52) U.S. Cl. 348/333.01; 348/333.02; 348/207

(57) ABSTRACT

A method for providing travel information is disclosed wherein the travel information is displayed on a display of a digital camera. The travel information may be stored in a memory device of the digital camera, and retrieved from the memory device prior to displaying the information.

### FIELD OF THE INVENTION

The present invention relates to provision of travel information in general, and particularly to use of digital cameras for providing, storing, retrieving, and downloading information.

### BACKGROUND OF THE INVENTION

Systems are known for providing travel and tourist information to sightseers and travelers. For example, U.S. Pat. No. 5,999,126 to Ito describes a system that provides positional and geographical information, such as global positioning system (GPS) location coordinates, as well as tourist information, such as tourist attractions at a particular locale. The information is displayed on a LCD display in a vehicle, for example.

U.S. Pat. No. 6,091,956 to Hollenberg describes a wireless system for providing services and time-critical information about places and events to mobile computers and their users. The information includes, for example, travel distances and transit times, entertainment, vendor messages, area attractions, communications, current locations of system users, traffic congestion information and user-generated information from bar-coded objects and digital photographs of scenes and other materials. The system includes a handset for wireless communications, which includes a bar-code reader and digital camera peripheral devices for mobile computers, a bracket for interfacing a mobile computer with radio to external systems, and other paraphernalia for reception, search and display of such information. The information is displayed on the screen of the mobile computer. 25

### SUMMARY OF THE INVENTION

The present invention provides a novel use of a digital camera, wherein the digital camera is transformed into a tourist information tool used to provide, store, retrieve and download any kind of information, particularly travel and tourist information.

The digital camera, which may be still or video, displays travel information on its display. In one embodiment of the invention, the travel information is stored in a memory of the digital camera, such as a flash memory. The travel information may be downloaded and updated, on-line or off-line, from a dedicated portal via the Internet, for example. A tourist carrying the digital camera can easily seek and retrieve travel information from the memory, and does not need any other equipment, such as a portable computer, for obtaining the tourist information. The tourist can send photographs taken with the digital camera to the dedicated portal, or share the photographs with others, such as via an electronic picture frame device.

It is noted that throughout the specification and claims the terms “travel” and “tourist”, in all of their inflections and derivatives, are used interchangeably.

There is thus provided in accordance with a preferred embodiment of the invention a method for providing travel information, which includes displaying travel information on a display of a digital camera.

In accordance with a preferred embodiment of the invention the travel information is stored in a memory device of the digital camera, and retrieved from the memory device prior to displaying the information.

Further in accordance with a preferred embodiment of the invention the travel information is downloaded from a dedicated portal. The downloading may be performed selectively by selecting a particular portion of travel information, or automatically from the dedicated portal via a modem connected to the digital camera.

Still further in accordance with a preferred embodiment of the invention the travel information is updated from a dedicated portal.

In accordance with a preferred embodiment of the invention information is transferred between the dedicated portal and the digital camera by means of a Media Application Protocol (MAP).

In accordance with a preferred embodiment of the invention the dedicated portal is accessible through the Internet. Information is preferably transferred between the dedicated portal and the Internet by means of a MAP.

Further in accordance with a preferred embodiment of the invention the dedicated portal includes a central processing unit.

Still further in accordance with a preferred embodiment of the invention the dedicated portal includes a portable recording medium.

Additionally in accordance with a preferred embodiment of the invention the dedicated portal includes a Uniform Resource Locator (URL).

In accordance with another preferred embodiment of the invention the dedicated portal includes a kiosk that stores therein the travel information, and which is communicable with the digital camera. The digital camera may communicate with the kiosk by means of wireless transceivers.

Further in accordance with a preferred embodiment of the invention the digital camera accesses the dedicated portal by a mobile communications device.

Still further in accordance with a preferred embodiment of the invention the mobile communications device is in communication with a positioning system that provides positional and geographical information.

Additionally in accordance with a preferred embodiment of the invention the method includes determining a geographical position of a user, and providing travel information for that particular position to the digital camera.

In accordance with a preferred embodiment of the invention the travel information includes one or more of the following: maps, travel distances and transit times, entertainment information, travel fare information, vendor messages, travel communication information, current location of a system user, traffic information, digital photographs of tourist sites, recommended travel routes, recommended local attractions, recommended tourist sites, recommended restaurants, weather forecast, and audio travel explanations.

In accordance with a preferred embodiment of the invention, the method further includes taking a photograph with the digital camera, and then storing the photograph in a memory device. The memory device may include a memory device of the digital camera, or alternatively, a memory device external of the digital camera.

Further in accordance with a preferred embodiment of the invention the method includes transmitting the photograph to a communications portal. Preferably the communications portal is accessible through the Internet.

In accordance with a preferred embodiment of the invention the photograph is transmitted to an electronic picture frame device.

Additionally in accordance with a preferred embodiment of the invention the digital camera includes a touch screen and the method further includes touching the touch screen to perform an action. For example, touching the touch screen may perform an action related to foreign currency exchange information or foreign language information.

There is also provided in accordance with a preferred embodiment of the invention apparatus for providing information including a dedicated portal including information, and a digital camera in communication with the dedicated portal, the digital camera including a display and a memory device, the information being storable in and retrievable from the memory device.

### BRIEF DESCRIPTION OF THE DRAWINGS

The present invention will be understood and appreciated more fully from the following detailed description taken in conjunction with the drawings in which:

FIG. 1 is a simplified illustration of a method and apparatus for providing travel information, in accordance with a preferred embodiment of the present invention;

FIG. 2 is a simplified illustration of using the apparatus of FIG. 1 for retrieving or downloading travel information, in accordance with a preferred embodiment of the present invention;

FIG. 3A is a simplified illustration of one use of a display screen of the apparatus of FIG. 1 for acquiring information or sending commands, in accordance with another preferred embodiment of the present invention;

FIGS. 3B and 3C are simplified illustrations of two different uses of a touch screen of the apparatus of FIG. 1 for acquiring information, in accordance with another preferred embodiment of the present invention; and

FIG. 4 is a simplified illustration of using the apparatus of FIG. 1 for transmitting travel photographs, in accordance with a preferred embodiment of the present invention.

### DETAILED DESCRIPTION OF A PREFERRED EMBODIMENT

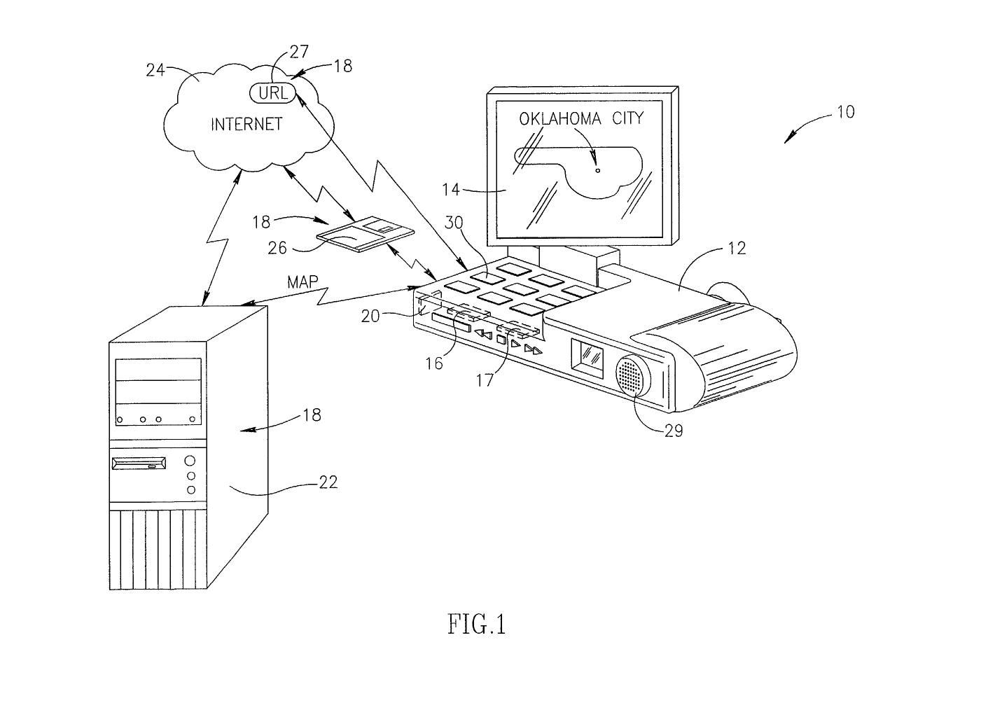

Reference is now made to FIG. 1, which illustrates a method and apparatus 10 for providing travel information, in accordance with a preferred embodiment of the present invention.

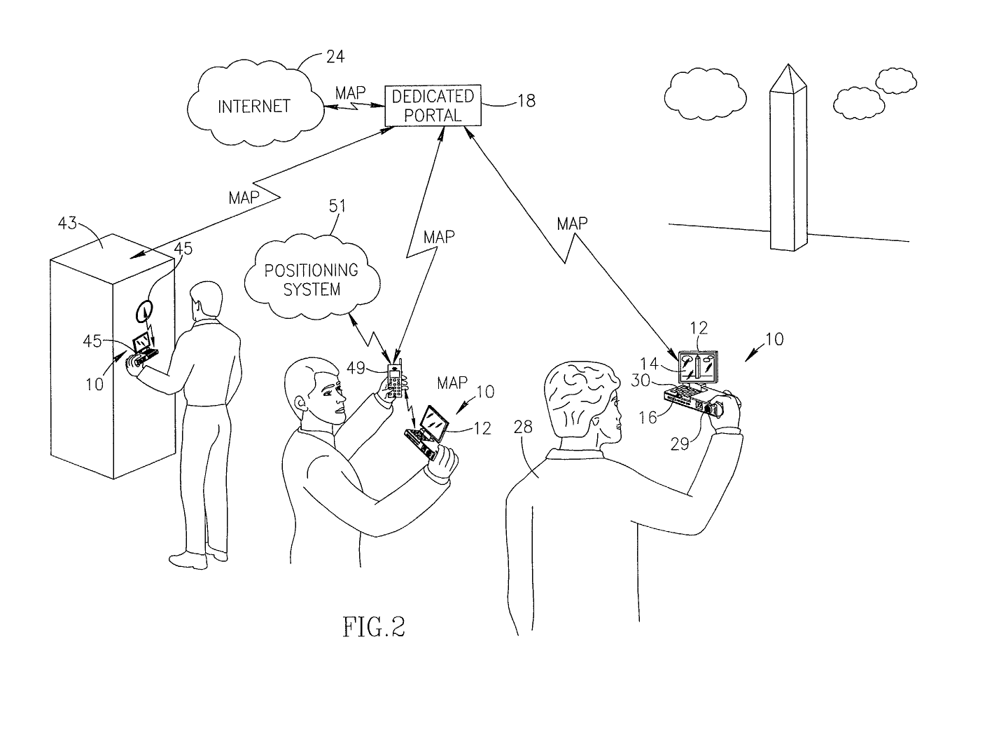

Apparatus 10 preferably includes a digital camera 12 that includes a display 14 and a memory device 16. Digital camera 12 may be any kind of camera with memory, such as a digital still camera (DSC) or digital video camera (DVC). Memory device 16 may be any kind of memory device in which travel information may be stored and retrieved therefrom, such as, but not limited to, non-volatile memory arrays, for example, flash memory arrays or erasable, programmable read only memory (EPROM) arrays. Digital camera 12 is in wired or wireless communication with a dedicated portal 18, such as via a modem 20 (or alternatively, USB, RS-232, or any other suitable I/O apparatus). Communication between digital camera 12 and dedicated portal 18 is described further hereinbelow with reference to FIG. 2.

Dedicated portal 18 may be a central processing unit 22 in communication with and accessible via the Internet 24. The manner in which dedicated portal 18 preferably communicates with the Internet 24 is described further hereinbelow. Alternatively, dedicated portal 18 may be a portable recording medium 26, such as a floppy disk or a CD-ROM (compact disk, read-only memory). Dedicated portal 18 has stored therein or accesses any kind of travel information, such as, but not limited to, travel maps, travel distances and transit times, entertainment information, travel fare information, vendor messages, travel communication information, current location of a system user, traffic information, digital photographs of tourist sites, recommended travel routes, recommended local attractions, recommended tourist sites, recommended restaurants, weather forecast, and audio travel explanations. Such travel information may be programmed or stored in dedicated portal 18, or may be downloaded from various Uniform Resource Locators (URLs) in the Internet 24, such as, www.travelocity.com or www.expedia.com, for example, which, inter alia, provide travel fare information. As another alternative, dedicated portal 11 may itself be a URL 27. Other examples of dedicated portals 18 are described hereinbelow with reference to FIG. 2.

Dedicated portal 18 may communicate with the Internet 24 in a variety of manners. For example, portal 18 may have a direct data link to a travel site, such as one of the URLs mentioned above, and simply download information therefrom. Different travel sites in different countries may have different formats and languages. Accordingly, dedicated portal 18 preferably includes format conversion and/or translation capability in order to download and store the information in a uniform format. Moreover, this format must be understandable and communicable to digital camera 12. In general, a Media Applications Protocol (MAP) may be developed for dedicated portal 18 that enables dedicated portal 18 to communicate with any source, media or format of travel information, and which downloads and stores the information in a format understandable and communicable to digital camera 12. Digital camera 12 may include a microprocessor 17, or any equivalent such as pre-programmed logic circuitry, that is programmed to understand the MAP and enable transfer of information between dedicated portal 18 and digital camera 12.

Referring additionally to FIG. 2, one method of carrying out the present invention is by downloading the travel information from dedicated portal 18, and storing the travel information in memory device 16 of digital camera 12. Downloading may be performed selectively by selecting a particular portion of the travel information from the Internet 24, for example. Alternatively, downloading may be performed automatically from dedicated portal 18 via modem 20. Of course, the travel information does not have to be downloaded each time, but rather may simply be retrieved from memory device 16. The travel information may be updated periodically, either automatically or selectively, such as by updates from the Internet 24. A user 28 presses appropriate control buttons 30 of digital camera 12 to retrieve the travel information from memory device 16 prior to displaying the information on display 14.

FIG. 2 illustrates an additional method of obtaining the travel information from dedicated portal 18. Dedicated portal 18 may be a kiosk 43 at a tourist attraction, which stores therein tourist information pertinent to that particular attraction, or additionally other tourist information as well. Kiosk 43 loads digital camera 12 by means of the MAP with the requisite travel information, either by a wired or wireless connection. For example, digital camera 12 and kiosk 43 may be provided with BLUETOOTH transceivers 45, or other kinds of wireless transceivers. BLUETOOTH is a code name for a technology specification for small form-factor, low-cost short-range radio links, such as links between portable communication and electronics devices. BLUETOOTH transceivers 45 are designed to operate in the 2.45 GHz unlicensed band. (BLUETOOTH currently hops in a pseudo-random sequence around 79 channels the range of 2.4-2.5 GHz. It is appreciated that these are exemplary values, and the invention is not limited to this range or to the BLUETOOTH technology.)

As an example of a wired connection between digital camera 12 and kiosk 43, digital camera 12 may be plugged into a connector (not shown) in kiosk 43, and information may be transferred to and stored in the flash memory of the camera via the connector.

FIG. 2 illustrates yet another method of obtaining the travel information from dedicated portal 18. Dedicated portal 18 may be accessed by digital camera 12 via a mobile communications device 49, such as a cell phone. In the illustrated embodiment, digital camera 12 is separate from mobile communications device 49. However, alternatively digital camera 12 may be fashioned as one unit with mobile communications device 49, such as a unitary digital camera and cell phone. Mobile communications device 49 may be in communication with a positioning system 51 that provides positional and geographical information, such as GPS location coordinates, or even the cellular communications network itself. Once the geographical position of the user is known, tourist information for that particular position may be provided by dedicated portal 18 for display on digital camera 12.

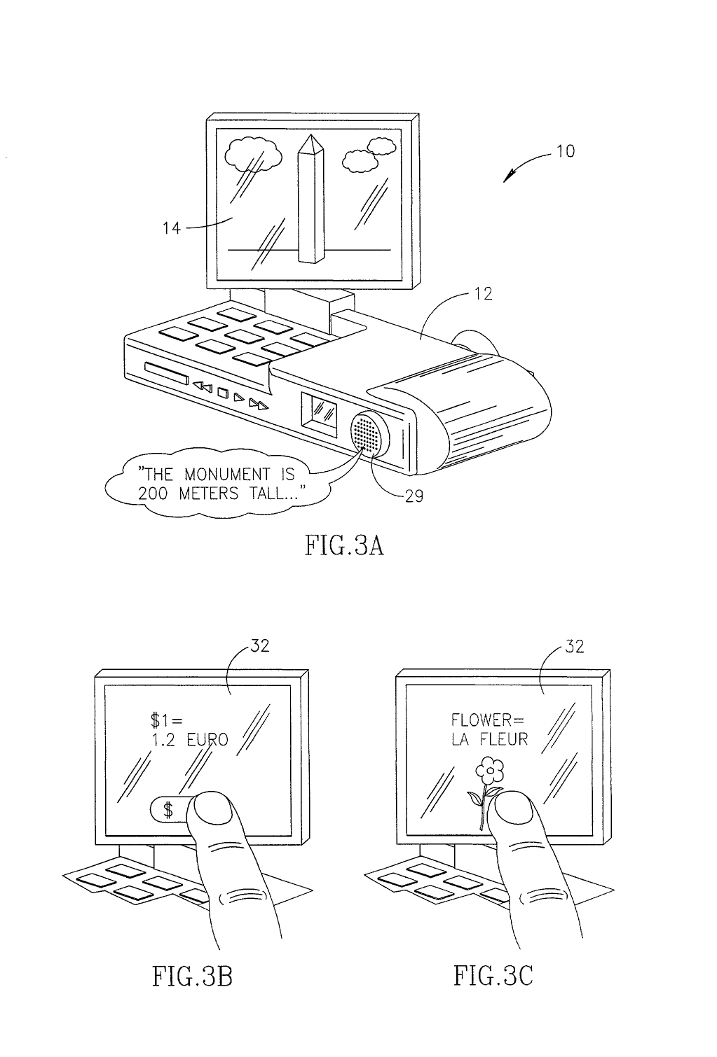

The user 28 may use typical functions available in digital cameras, such as zoom or pan, to navigate to different portions of display 14. In addition, software may be provided for various user-friendly features, such as to provide cursors for “clicking” on various items in the display and for effecting commands related to those items for actuating user-actuated processes. For example, as seen in FIG. 3A, the software may enable the user 28 to choose a monument shown in display 14, whereupon an audio explanation of the monument is provided and heard through a speaker 29, the explanation being taken from the stored travel information, or downloaded on-line from the Internet 24.

As another example, digital camera 12 may include a touch screen 32, which may be touched to perform an action. For example, as shown in FIG. 3B, foreign currency exchange information is displayed on display 14. Touching a particular currency on the touch screen 32 provides an updated exchange rate for converting from that currency to another, for example. As another example, shown in FIG. 3C, a choice of foreign languages is displayed on display 14. Touching a particular word on the touch screen 32 provides a translation of that word into another language, for example.

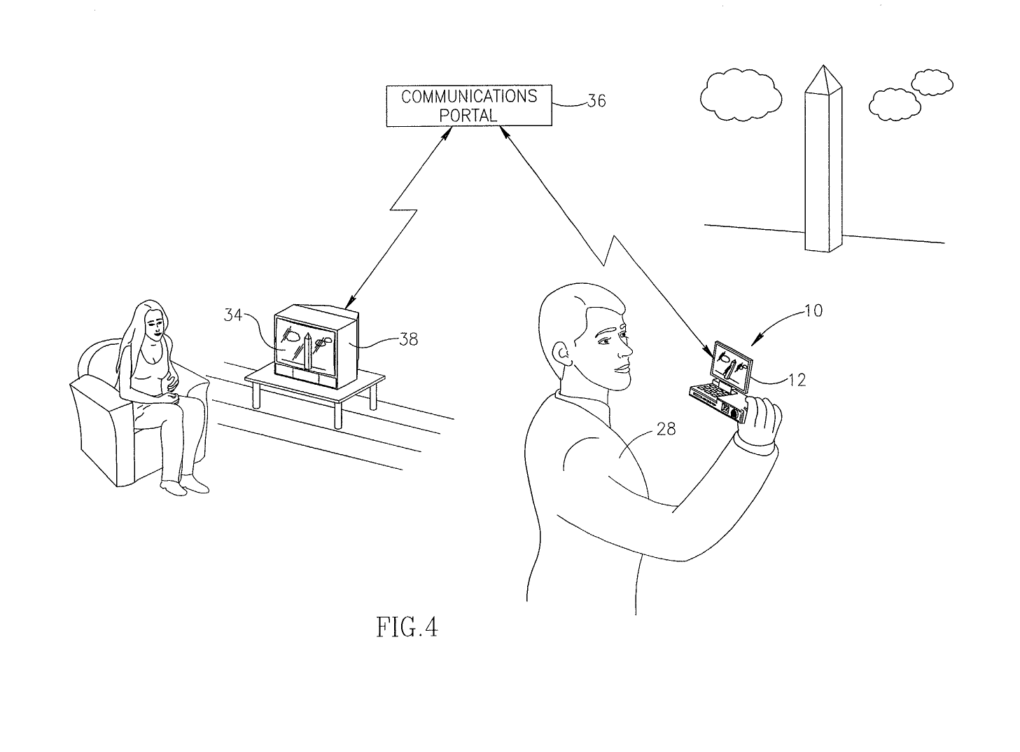

Reference is now made to FIG. 4, which illustrates using apparatus 10 for transmitting travel photographs, in accordance with a preferred embodiment of the present invention. User 28 may take a photograph 34 with digital camera 12. The photograph 34 may be stored in memory device 16 of digital camera 12, or alternatively, may be stored in an external memory device, such as portable recording medium 26. The photograph 34 is transmitted to a communications portal 36, which may be the same as, or operate similarly to, dedicated portal 18. The photograph 34 may be used to enrich or update the database used by dedicated portal 18 and memory device 16 of digital camera 12.

As another alternative, photograph 34 may be transmitted to an electronic picture frame device 38 for viewing by persons who are not in the same place as user 28. Electronic picture frame device 38 is known in the art and is commercially available, for example, on the World Wide Web from CEIVA LOGIC INC., West Hollywood, Calif.

The present invention is not only limited to travel and tourist information. Rather, the digital camera may be used to provide, store, retrieve and download any kind of information as well. Thus, the present invention transforms the digital camera into an all-purpose information tool.

It will be appreciated by person skilled in the art, that the present invention is not limited by what has been particularly shown and described herein above. Rather the scope of the present invention is defined only by the claims which follow:

What is claimed is:

1. A method for providing travel information, the method comprising:
displaying travel information on a display of a digital camera.

2. The method according to claim 1 and further comprising storing said travel information in a memory device of said digital camera, and retrieving said travel information from said memory device prior to displaying said information.

3. The method according to claim 1 and further comprising downloading said travel information from a dedicated portal.

4. The method according to claim 1 and further comprising updating said travel information from a dedicated portal.

5. The method according to claim 3 and further comprising storing said travel information in a memory device of said digital camera.

6. The method according to claim 3 wherein the downloading is performed selectively by selecting a particular portion of travel information.

7. The method according to claim 3 wherein the downloading is performed automatically from said dedicated portal via a modem connected to said digital camera.

8. The method according to claim 3 wherein information is transferred between said dedicated portal and said digital camera by means of a Media Application Protocol (MAP).

9. The method according to claim 3 wherein said dedicated portal is accessible through the Internet.

10. The method according to claim 9 wherein information is transferred between said dedicated portal and the Internet by means of a MAP.

11. The method according to claim 3 wherein said dedicated portal comprises a central processing unit.

12. The method according to claim 3 wherein said dedicated portal comprises a portable recording medium.

13. The method according to claim 3 wherein said dedicated portal comprises a Uniform Resource Locator (URL).

14. The method according to claim 3 wherein said dedicated portal comprises a kiosk that stores therein said travel information, and which is communicable with said digital camera.

15. The method according to claim 14 wherein said digital camera communicates with said kiosk by means of wireless transceivers.

16. The method according to claim 3 wherein said digital camera accesses said dedicated portal by a mobile communications device.

17. The method according to claim 16 wherein said mobile communications device is in communication with a positioning system that provides positional and geographical information.

18. The method according to claim 17 and further comprising determining a geographical position of a user, and providing travel information for that particular position to said digital camera.

19. The method according to claim 1 wherein said travel information comprises at least one of maps, travel distances and transit times, entertainment information, travel fare information, vendor messages, travel communication information, current location of a system user, traffic information, digital photographs of tourist sites, recommended travel routes, recommended local attractions, recommended tourist sites, recommended restaurants, weather forecast, and audio travel explanations.

20. The method according to claim 1 and further comprising taking a photograph with said digital camera.

21. The method according to claim 20 and further comprising storing said photograph in a memory device.

22. The method according to claim 21 wherein said memory device comprises a memory device of said digital camera.

23. The method according to claim 21 wherein said memory device comprises a memory device external of said digital camera.

24. The method according to claim 20 and further comprising transmitting said photograph to a communications portal.

25. The method according to claim 24 wherein said communications portal is accessible through the Internet.

26. The method according to claim 20 and further comprising transmitting said photograph to an electronic picture frame device.

27. The method according to claim 1 wherein said digital camera comprises a touch screen and the method further comprises touching said touch screen to perform an action.

28. The method according to claim 1 wherein touching said touch screen performs an action related to foreign currency exchange information.

29. The method according to claim 1 wherein touching said touch screen performs an action related to foreign language information.

30. A method for providing information, the method comprising:
storing information in a memory device of a digital camera, and retrieving said information from said memory device prior to displaying said information.

31. The method according to claim 30 and further comprising downloading said information to said memory device of said digital camera from a dedicated portal.

32. Apparatus for providing information comprising:
a dedicated portal comprising information; and
a digital camera in communication with said dedicated portal, said digital camera comprising a display and a memory device, said information being storable in and retrievable from said memory device.

33. Apparatus according to claim 32 and further comprising a modern in communication with said digital camera and said dedicated portal.

34. Apparatus according to claim 32 wherein said information comprises at least one of maps, travel distances and transit times, entertainment information, travel fare information, vendor messages, travel communication information, current location of a system user, traffic information, digital photographs of tourist sites, recommended travel routes, recommended local attractions, recommended tourist sites, recommended restaurants, weather forecast, and audio travel explanations.

35. Apparatus according to claim 32 and further comprising an electronic picture frame device in communication with said digital camera.

36. Apparatus according to claim 32 wherein said digital camera further comprises a touch screen.
